(19) United States
(12) Patent Application Publication
(10) Pub. No.: US 2026/0258677 A1
(43) Pub. Date: Sep. 3, 2026

(54) ASSEMBLING ELEMENT FOR AN OUTER HANDLE DEVICE

(71) Applicant: MINEBEA ACCESSSOLUTIONS ITALIA S.P.A., Pianezza (IT)

(72) Inventors: Thomas PEYNOT, PIANEZZA (IT); Davide GRECO, Pianezza (IT)

(73) Assignee: MINEBEA ACCESSSOLUTIONS ITALIA S.P.A., Pianezza (IT)

(21) Appl. No.: 19/549,877

(22) Filed: Feb. 25, 2026

(30) Foreign Application Priority Data
Feb. 28, 2025 (EP) 251611216

(51) Int. Cl. E05B 79/06

(52) U.S. Cl. CPC E05B 79/06

(57) ABSTRACT

An assembling element assembles a lever to a bracket of a door handle of a vehicle in such a way that the lever can rotate with respect to the bracket around an axis of rotation. The assembling element includes a head and a skirt part. The head is located at a first end of the assembling element. The assembling element is configured such that, when the lever is assembled to the bracket, the skirt part is located at least partially between the bracket and the lever in a direction orthogonal to the axis of rotation, allowing the lever to rotate with respect to the skirt part around the axis of rotation.

### CROSS-REFERENCE TO RELATED APPLICATIONS

This application claims priority to and the benefit of EP 25161121.6 filed on February 28, 2025. The disclosure of the above application is incorporated herein by reference.

### FIELD

The present disclosure relates to an assembling element configured to assemble a lever to a bracket of a door handle of a vehicle. The disclosure also concerns a bracket of a door handle of a vehicle, an assembly for a door handle, and a door handle of a vehicle and associated methods.

### BACKGROUND

The statements in this section merely provide background information related to the present disclosure and may not constitute prior art.

Vehicle door handle mechanisms that allow the transmission of movement from the door handle to a door latch comprise several moving parts, including lever(s) that can be assembled on a door bracket.

Commonly used techniques for assembling a lever to a bracket of a door handle of a vehicle include the use of rivets with washers or screw with washers and nuts. As an alternative, the lever can be a bayonet mounted on the bracket. This assembling process enables a lever to be assembled by pushing in the bracket and turning the lever with respect thereto. However, these assembling processes require to add grease between the lever and the bracket to ensure a correct rotation of the lever with regards to the bracket. This means additional costs due to longer assembly times and the purchase of additional grease.

### SUMMARY

This section provides a general summary of the disclosure and is not a comprehensive disclosure of its full scope or all of its features.

In view of the state of the art and the problems it raises, it is necessary to develop a solution that reduces costs and complexity of the process of assembling a lever to a bracket of a door handle of a door vehicle without substantially complexifying the design of the bracket and of the handle mechanism.

To this end, the invention relates to an assembling element configured to assemble a lever to a bracket of a door handle of a vehicle in such a way that the lever can rotate with respect to the bracket around an axis of rotation,

the assembling element comprising a head and a skirt part wherein the head is located at a first end of the assembling element,

the assembling element being configured such that, when the lever is assembled to the bracket, the skirt part is located at least partially between the bracket and the lever, in a direction orthogonal to the axis of rotation, allowing the lever to rotate with respect to the skirt part around the axis of rotation.

The invention can also comprise the following features, taken alone or according to any technically possible combination:

the assembling element comprises a body, wherein the skirt part extends from the head, the skirt part surrounding at least a part of the body, the body being connected to the head and the body being configured to be inserted through the bracket,

the skirt part comprises a peripheral wall, the peripheral wall presenting an outer surface and an inner surface, the peripheral wall being configured such that, when the lever is assembled to the bracket, the outer surface of the skirt part is in contact with the lever and the inner surface is in contact with the bracket,

the outer surface of the skirt part is treated to reduce its coefficient of friction,

the assembling element comprises an assembling part, wherein the assembling part is located at a second end of the assembling element opposite to the first end, the body connecting the head and the assembling part, the assembling part having a shape configured to maintain the lever between the bracket and the head in the direction of the axis of rotation, when the lever is assembled to the bracket,

the assembling part is configured to be inserted though the bracket from a first side of the bracket such that, when the lever is assembled to the bracket, the lever is located on the first side of the bracket,

the assembling part comprises at least one protrusion configured to be trapped, for example sandwiched, between two stops of the bracket when the lever is assembled to the bracket, so as to limit the rotation of the assembling element with respect to the bracket,

the assembling element is configured so as to be rotated with respect to the bracket around the axis of rotation, to assemble the lever to the bracket, once the body is inserted through the bracket,

the at least one protrusion presents a rounded curved and/or inclined surface configured such that, upon rotation of the assembling element with respect to the bracket around the axis of rotation, the rounded curved and/or inclined surface slides on a ramp of the bracket,

the head comprises a peripheral part, configured such that, when the lever is assembled to the bracket, the lever is located at least partially between the peripheral part and the bracket in the direction to the axis of rotation,

the head presents a recess delimited by a bottom wall and a side wall of the head, the recess extending from the bottom wall, away from the body and/or the assembling part, for example the recess opening out through a top surface of the head, the top surface facing away from the body and/or the assembling part,

The invention also concerns a bracket configured to be assembled to at least one lever by means of the assembling element, the bracket presenting an opening configured such that, when the bracket is assembled to the lever, the body of the assembling element is inserted through the opening.

The invention also concerns an assembly for a door handle comprising the bracket, at least one lever and at least one assembling element, wherein the assembling element is configured to assemble the lever to the bracket.

The assembling element and the bracket are configured such that, when the lever is assembled to the bracket, the skirt part and the lever are configured in such a way that the lever may rotate with regards to the assembling element without the need to provide grease between the lever and the skirt part, and/or the skirt part and the lever are configured in such a way that the surfaces of the skirt part and of the lever that are in contact present a reduced coefficient of friction.

The invention also concerns a door handle the assembly, wherein the lever is assembled to the bracket by means of the assembling element.

The present invention will be described with reference to the accompanying drawings, which are provided for illustrative purposes and should not be construed as limiting the scope of the invention. The drawings illustrate particular examples of the invention, but other variations are possible without departing from the spirit of the invention. The same or similar elements may be designated by different reference numerals in the different figures.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a sectional view of an assembly comprising a bracket, a lever and an assembling element according to an example of the invention.

FIG. 2 shows the assembling element of FIG. 1.

FIG. 3 shows a perspective view of the bracket, the lever and the assembling element of FIG. 1.

FIG. 4 shows a perspective view of an assembling part of the assembling element of FIG. 1 mounted on the bracket.

FIG. 5 shows a side view of the assembling part of the assembling element of FIG. 1.

FIG. 6 shows a sectional view of an assembly of the bracket, the lever and the assembling element of FIG. 1 assembled together.

FIG. 7a shows a perspective view of the assembling element of FIG. 1 viewed from the head side.

FIG. 7b shows an enlargement of FIG. 7a illustrating in more details a recess of the head.

FIG. 8 shows a perspective view of the assembling part of FIG. 1 viewed from the second end side, illustrating the structure of a skirt part of the assembling element.

FIG. 9a shows a perspective view of the first side of the bracket of FIG. 1.

FIG. 9b shows a perspective view of the second side of the bracket of FIG. 1.

FIG. 10 shows a perspective view of an opening and several stops of the bracket of FIG. 1.

FIG. 11a shows a front view of an opening of the bracket of FIG. 1.

FIG. 11b shows a perspective view of the opening of FIG. 11a.

FIG. 12 shows a perspective view of a door handle.

FIG. 13 shows a flowchart of a method of assembly of a lever to a bracket of the door handle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

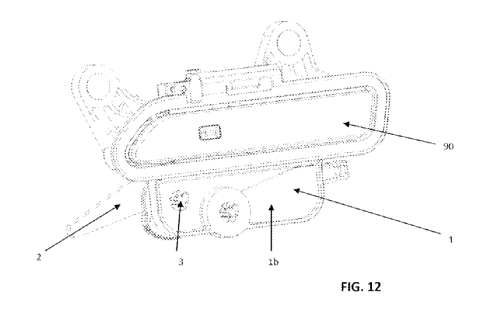

With reference to FIG. 12, a door handle 90 of a vehicle is described. The door handle 90 may be configured to be mounted to another part of a vehicle door, for example to a vehicle door panel. The door handle 90 may comprise an assembly 100 for a door handle. The door handle 90 may be of the flush handle type.

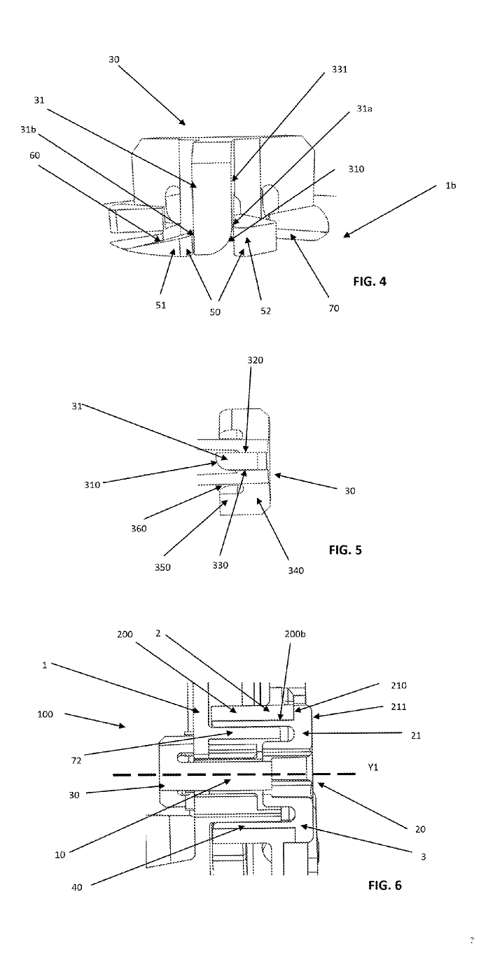

With reference to FIGS. 4, 6 and 12, the assembly 100 for a door handle is described. For example, the assembly 100 comprises a bracket 1, at least one lever 2 and at least one assembling element 3, wherein the at least one assembling element 3 assemble the at least one lever 2 to the bracket 1.

The bracket 1 may present a first side 1a. The first side 1a may be configured to face the inside of the vehicle, for example when the door handle 90 is mounted on the vehicle, for example to face away the outside of the vehicle. The bracket 1 may present a second side 1b. The second side 1b may be configured to face the outside of the vehicle, for example when the door handle 90 is mounted on the vehicle, for example to face away the inside of the vehicle.

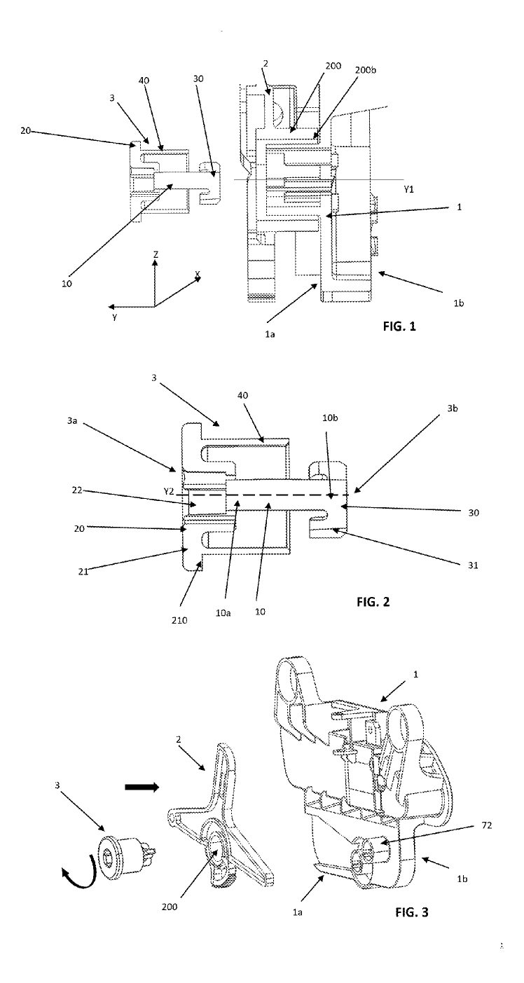

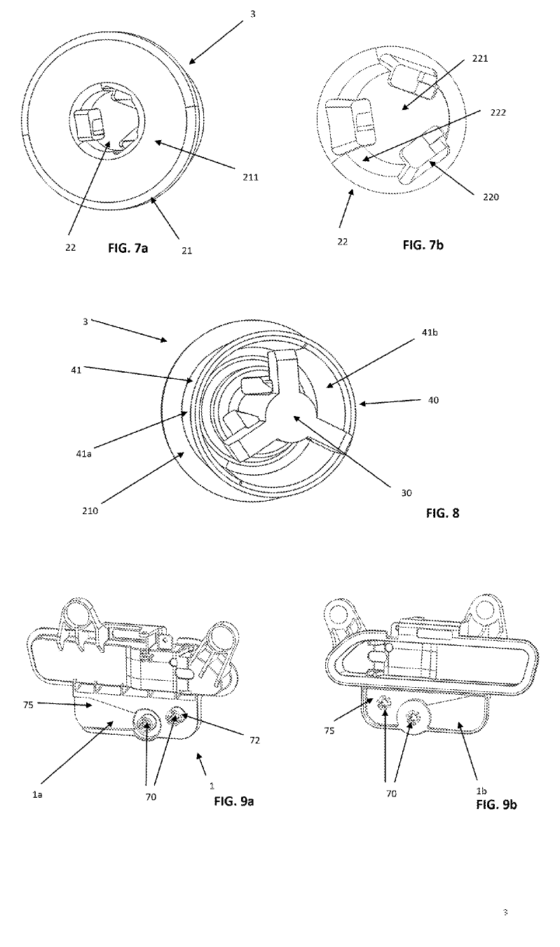

With reference to FIGS. 1 to 8, an assembling element 3 is described, for example the at least one assembling element 3 of the assembly 100.

The assembling element 3 is configured to assemble a lever 2, for example the at least one lever 2 of the assembly 100, to the bracket 1 of the door handle 90 of a vehicle, for example of the assembly 100, in such a way that the lever 2 can rotate with respect to the bracket 1 around an axis of rotation Y1, for example wherein the axis of rotation Y1 is fixed with regards to the bracket 1. The axis of rotation Y1 may have a first sense oriented along the axis from the second side 1b to the first side 1a and/or oriented towards the inside of the vehicle, for example when the door handle 90 is mounted on the vehicle, for example away from the outside of the vehicle. The axis of rotation Y1 may have a second sense oriented along the axis from the first side 1a to the second side 1b and/or oriented towards the outside of the vehicle, for example when the door handle 90 is mounted on the vehicle, for example away from the inside of the vehicle. The first sense and the second sense may be opposed senses of the same direction, that of the axis of rotation Y1.

Alternatively, or in combination, the assembling element 3 may be configured to assemble a or the lever 2, for example the at least one lever 2 of the assembly 100, to the bracket 1 of the door handle 90 of a vehicle, for example of the assembly 100, in such a way that the lever 2 is fixed in translation with regards to the bracket 1.

As illustrated in FIG. 2, the assembling element 3 comprises a head 20 and a skirt part 40. For example, the assembling element 3 comprises a body 10. The head 20 is located at a first end 3a of the assembling element 3.

The head 20 may form the first end 3a of the assembling element 3.

The assembling element 3 is configured such that, when the lever 2 is assembled to the bracket 1, the skirt part 40 is located at least partially between the bracket 1 and the lever 2, for example in a direction orthogonal to the axis of rotation Y1, for example between a base portion 200 of the lever 2 and the shaft portion 72 of the bracket 1, allowing the lever 2 to rotate with respect to the skirt part 40 around the axis of rotation Y1.

Thanks to this invention, and specially to the assembling part 3, it may be possible to assemble the lever 2 to the bracket 1 without using grease or by using a reduced amount of grease. This may reduce the cost of the assembly.

The body 10 may be connected to the head 20. The body 10 may be configured to be inserted through the bracket 1.

For example, the assembling element 3 is configured so as to be rotated with respect to the bracket 1 around the axis of rotation Y1, to assemble the lever 2 to the bracket 1, once the body 10 is inserted through the bracket 1. This may allow to assemble the lever 2 to the bracket 1 only by inserting and rotating the assembling element 3 with respect to the bracket 1.

The assembling element 3 may comprise an assembling part 30.

The assembling element 3 may be made in one piece, for example the assembling element 3 is a single piece that is not composed of several smaller pieces assembled together. For example, the body 10, the skirt part 40 and the head 20 form a single piece. For example, the body 10, the assembling part 30 and the head 20 form a single piece. For example, the body 10, the assembling part 30, the skirt part 40 and the head 20 form a single piece. This may eliminate the need to assemble each part of the assembling element 3 to obtain the assembling element 3 ready to assemble the lever 2 to the bracket 1. This may also eliminate the need to assemble each part of the assembling element 3 to assemble the lever 2 to the bracket 1. This simplifies the steps involved in the assembling of the lever 2 to the bracket 1. Alternatively, the assembling element 3 may be made of several pieces, for example fixed together.

The assembling element 3 may be obtained by moulding.

The assembling part 30 is for example located at a second end 3b of the assembling element 3 opposite to the first end 3a, for example forms the second end 3b. For example, the body 10 extends between the first end 3a of the assembling element 3 and the second end 3b of the assembling element 3.

The body 10 may connect the head 20 and the assembling part 30. For example, the body 10 is a single piece. For example, the head 20 is a single piece. For example, the assembling part 30 is a single piece.

For example, the body 10 extends from the head 20 to the assembling part 30 along an assembling element axis Y2 such that, for example wherein the assembling element axis Y2 is fixed with regards to the assembling element 3. For example, when the lever 2 is assembled to the bracket 1, the assembling part axis Y2 is substantially coaxial with the axis of rotation Y1. The axis of rotation Y2 may have a first sense oriented along the axis from the assembling part 30 to the head 20. The axis of rotation Y2 may have a second sense oriented along the axis from the head 20 to the assembling part 30. The first sense and the second sense may be opposed senses of the same direction, that of the axis of rotation Y2.

The assembling part 30 has a shape configured to maintain the lever 2 between the bracket 1 and the head 20, for example in the direction of the axis of rotation Y1, when the lever 2 is assembled to the bracket 1.

The assembling part 30 may limit the rotation of the assembling element 3 with respect to the bracket 1 when the lever 2 is assembled to the bracket 1. This may allow to prevent the rotation of the assembling element 3, to keep the lever 2 assembled to the bracket 1.

The assembling part 30 may be configured to be inserted though the bracket 1 from the first side 1a of the bracket 1 such that, when the lever 2 is assembled to the bracket 1, the lever 2 is located on the first side 1a of the bracket 1. This may allow the lever 2 to be assembled on the same side as the side from which the assembling element 3 is inserted, therefore, to assemble the lever 2 by inserting the assembling element 3 in the bracket 1, it may be only needed to operate on only one side of the bracket 1 and not on both sides.

When the lever 2 is assembled to the bracket 1, the assembling part 30 may limit the translation of the assembling element 3 towards the inside of the vehicle with respect to the bracket 1, for example when the door handle 90 is mounted on the vehicle, for example towards the first sense of the axis Y1. This may allow to prevent the translation of the assembling element 3 towards the inside of the vehicle, for example when the door handle 90 is mounted on the vehicle, for example towards the first sense of the axis Y1, to keep the lever 2 assembled to the bracket 1.

The assembling part 30 may comprise at least one protrusion 31, for example one protrusion 31 or several protrusions 31, for example the at least one protrusion 31, for example each protrusion 31, being configured to be trapped, for example sandwiched, between two stops 50 of the bracket 1 when the lever 2 is assembled to the bracket 1, for example so as to limit the rotation of the assembling element 3 with respect to the bracket 1. For example, when the lever 2 is assembled to the bracket 1, the at least one protrusion 31 is blocked, for example by the two stops 50, for example from rotating according to the axis of rotation Y1, for example in two opposite senses. This may allow to block the rotation of the assembling element 3 to keep the lever 2 assembled to the bracket 1, thanks to, for example only thanks to, the structure of the assembling element 3 and of the bracket 1 without needing additional fasteners or adhesive substances.

The at least one protrusion 31 may present a first stop surface 31a and a second stop surface 31b. For example, the second stop surface 31b is flat.

When the at least one protrusion 31 is trapped, for example sandwiched, between the two stops 50. The at least one protrusion 31 may be blocked by the contact of the first stop surface 31a against a first stop 51 of the two stops 50, for example by a first stop face 510 of the first stop 51, and by the contact of the second stop surface 31b against a second stop 52 of the two stops 50, for example by a second stop face 520 of the second stop 52.

For example, when the lever 2 is assembled to the bracket, each of the several protrusions 31 is sandwiched between two corresponding stops such as the two stops 50. Alternatively, for example, when the lever 2 is assembled to the bracket, only one or certain protrusions of the several protrusions 31 are sandwiched between two corresponding stops such as the two stops 50. For example, when the lever 2 is assembled to the bracket, only one protrusion 31 of the several protrusions 31 is sandwiched between two corresponding stops such as the two stops 50.

For example, to each protrusion configured to be thus sandwiched corresponds two dedicated stops which are specific to one protrusion only.

With reference to FIG. 4, the assembling part 30 may comprise three protrusions 31, for example such as the at least one protrusion 31, and for example, when the lever 2 is assembled to the bracket, each of the three protrusions 31 may be sandwiched between two corresponding stops such as the two stops 50.

For example, the several protrusions 31 may be uniformly distributed around the axis of rotation Y2, for example at uniform angles, for example such that the angle between two consecutive protrusions of the several protrusions 31 around the axis of rotation Y2 are the same.

For example, the at least one protrusion 31 extends radially from the body 10. For example, the at least one protrusion 31 extends radially with regards to the assembling element axis Y2.

The at least one protrusion 31 may present a first face 320 and a second face 330. For example, the first face 320 of the at least one protrusion 31 and the second face 330 of the at least one protrusion 31 extend from the body 10, for example the first face 320 of the at least one protrusion 31 and the second face 330 of the at least one protrusion 31 extend radially from the body 10.

The first face 320 of the at least one protrusion 31 may comprise the first stop surface 31a and the second face 330 of the at least one protrusion 31 may comprise the second stop surface 31b.

The at least one protrusion 31 may present a rounded curved and/or inclined surface 310. The rounded curved and/or inclined surface 310 may be configured such that, upon rotation of the assembling element 3 with respect to the bracket 1 around the axis of rotation Y1, for example around the assembling element axis Y2, the rounded curved and/or inclined surface 310 may slide on a ramp 60 of the bracket 1, for example to assemble the lever 2 to the bracket 1. This may allow to facilitate rotation of the assembling element 3 with respect to the bracket 1 around the assembling element axis Y2. The second face 330 may comprise the rounded curved and/or inclined surface 310 and the rounded curved and/or inclined surface 310 may be linked to first face 320, for example the rounded curved and/or inclined surface 310 may be in contact to, for example extending in continuity with the first face 320. For example, the rounded curved and/or inclined surface 310 and the first face 320 share a common edge.

For example, rotation of the assembling element 3 with respect to the bracket 1 around the assembling element axis Y1, for example when the assembling part axis Y2 is substantially coaxial with the axis of rotation Y1, to assemble the lever 2 to the bracket 1, causes the at least one protrusion 31 to slide on the ramp 60, for example thus moving in translation along axis Y1 on top of the rotation around the same axis Y1 in second sense of the axis Y1, until the at least one protrusion 31 reaches an upper end of the ramp 60, and goes beyond the upper end, such that the at least one protrusion 31 is no longer maintained by the ramp, in particular is no longer in contact with the ramp 60, and the at least one protrusion 31 moves back, for example in translation, for example following the first sense of the axis Y1, until being blocked by the second side 1b and/or being sandwiched between the two stops 50.

The at least one protrusion 31 may be flexible, for example flexible enough to reach the position in which the at least one protrusion 31 is sandwiched between the two stops 50. For example, the at least one protrusion 31 is configured to be bent when the at least one protrusion 31 slides on the ramp 60 of the bracket 1 to assemble the lever 2 to the bracket 1. The at least one protrusion 31 may present an initial shape, as illustrated in FIG. 5, when the lever 2 is not assembled to the bracket 1. For example, the at least one protrusion 31 is bended and loses its initial shape, for example by being deformed, as the at least one protrusion 31 slides on the ramp 60 of the bracket 1 to assemble the lever 2 to the bracket 1. For example, the at least one protrusion 31 presents the initial shape when the at least one protrusion 31 is sandwiched between the two stops 50. For example, the at least one protrusion 31 returns to the initial shape, when the at least one protrusion 31 is no longer in contact with the ramp 60 of the bracket 1. This may allow to block the at least one protrusion 31 between the two stops 50 after the rotation of the transmission element 5 because further rotation of the assembling element 5 is not possible once the at least one protrusion 31 has regained the initial shape. This may allow to avoid disassembly of the lever 2 and of the assembling part 3 from the bracket 1 when the at least one protrusion 31 is sandwiched between the two stops 50.

For example, the second face 330 of the at least one protrusion 31 comprises the rounded curved and/or inclined surface 310 and for example a flat surface 331. For example, the rounded curved and/or inclined surface 310 may be in contact to, for example extending in continuity with the flat surface 331. The first face 320 may be flat. For example, the flat surface 331 is parallel the first face 320 of the at least one protrusion 31.

For example, the first face 320 of the at least one protrusion is flat and the second face 330 of the at least one protrusion 31 comprises the flat surface 331 and the partially rounded curved and/or inclined surface 310.

When the lever 2 is assembled to the bracket 1, the rounded curved and/or inclined surface 310 of the at least one protrusion 31 may be in contact with the second side 1b of the bracket 1. This may allow to block the translation of the assembling part 30 towards the first side 1a of the bracket 1 with regards to the bracket 1, to keep the lever 2 assembled to the bracket 1, for example only thanks to the structure of the assembling element 3 and of the bracket 1, without needing additional fasteners or adhesive substances.

The at least one protrusion 31 may comprise a radial part 340 and a contact part 350. The contact part 350 and the radial part 340 may form the at least one protrusion. The contact part 350 and the radial part 340 may be fixed to each other and/or be made in one piece.

The radial part 340 may extend from the body 10, for example radially from the assembling part axis Y2. The contact part 350 may extend from the radial part 340, for example towards the head 20 of the assembling element 3, for example towards the bracket 1, for example towards the first side 1a and/or second side 1b of the bracket 1, when the lever 2 is assembled to the bracket 1, for example parallel to the assembling part axis Y2.

The contact part 350 and the radial part 340 may extend in mutually orthogonal directions.

When the lever 2 is assembled to the bracket 1, the contact part 350 of the at least one protrusion 31 may be in contact with the second side 1b of the bracket 1. The contact part 350 may present the rounded curved and/or inclined surface 310.

The contact part 350 and the body 10 may be separated by a spacing 360.

The contact part 350 may present a portion of the first face 320 of the at least one protrusion 31, a portion of the second face 330 of the at least one protrusion 31 and the rounded curved and/or inclined surface 310. The radial part 340 may present a portion of the first face 320 of the at least one protrusion 31 and a portion of the second face 330 of the at least one protrusion 31

For example, the at least one protrusion 31 has a hook shape.

As illustrated in FIG. 2, the body 10 may extend between a head end 10a and an assembling end 10b. For example, the assembling part 30 of the assembling element 3 is located on the assembling end 10b and the head 20 of the assembling element 3 is located on the head end 10a.

When the lever 2 is assembled to the bracket 1, the body 10 of the assembling element 3 may pass through the bracket 1. For example, the assembling end 10b protrudes of the second side 1b of the bracket 1. For example, the head end 10a protrudes of the first side 1a of the bracket 1.

When the lever 2 is assembled to the bracket 1, the body 10 may pass through an opening 70 of the bracket 1.

The body 10 may be configured to, upon rotation of the assembling element 3 with respect to the bracket 1 around the assembling element axis Y2, rotate inside the opening of the bracket 1.

For example, the area of the cross-section of the body 10 in a plane orthogonal to the assembling element axis Y2 increases from the assembling end 10b to the head end 10a.

The body 10 may present an elongated shape.

When the lever 2 is assembled to the bracket 1, the head 20 may limit the translation of the assembling element 3 towards the inside of the vehicle with respect to the bracket 1, for example towards the second sense along axis Y1, for example when the door handle 90 is mounted on the vehicle, for example thanks to the contact between a lower surface 210, for example a peripheral lower surface as described hereafter, of the head 20 and the lever 2, for example a base portion 200 of the lever 2. This may allow to prevent the translation of the assembling element 3 towards the inside of the vehicle, for example when the door handle 90 is mounted on the vehicle to keep the lever 2 assembled to the bracket 1.

The head 20 may comprise a peripheral part 21. The peripheral part 21 may be configured such that, when the lever 2 is assembled to the bracket 1, the lever 2 is located at least partially between the peripheral part 21 and the bracket 1 along, for example following, in the direction of, the axis of rotation Y1.

The peripheral part 21 may present, for example form a lower surface 210, for example a peripheral lower surface 210, the peripheral lower surface 210 being configured such that, when the lever 2 is assembled to the bracket 1, the lever 2 is located at least partially between the peripheral lower surface 210 and the bracket 1 in the direction to the axis of rotation Y1. This may allow to block the translation of the assembling part 30 towards the inside of the vehicle with respect to the bracket 1, for example towards the second sense of the axis Y1, for example when the door handle 90 is mounted on the vehicle to keep the lever 2 assembled to the bracket 1, only thanks to the structure of the assembling element 3 and of the bracket 1 without needing additional fasteners or adhesive substances.

The peripheral lower surface 210 may be ring-shaped.

For example, the cross-sections of the peripheral part 21 orthogonal to the assembling element axis Y2 are larger than the cross sections of the body 10 of the assembling element 3 orthogonal to the assembling element axis Y2. For example, the cross-sections of the peripheral part 21 orthogonal to the assembling element axis Y2 have a larger external perimeter than the cross sections of the body 10 of the assembling element 3 orthogonal to the assembling element axis Y2.

The head 20 may present a recess 22 delimited by a bottom wall 221 and a side wall 222 of the head 20, the recess 22 extending from the bottom wall 221, away from the body 10 and/or the assembling part 30. For example, the recess 22 opening out through a top surface 211 of the head 20. The top surface 211 may face away from the body 10 and/or the assembling part 30. For example, the bottom wall 221 and the side wall 222 are linked.

The bottom wall 221 may be linked to the body 10 of the assembling element 3, more particularly to the head 20 end of the body 10. For example, the bottom wall 221 is connected to the body 10, for example so that the head 20 and the body 10 are fixed with each other, for example form a single piece.

For example, when the lever 2 is assembled to the bracket 1, the recess 22 is configured so that the bottom wall 221 and the side wall 222 are at least partially inserted through the bracket 1, from example through a shaft portion 72 of the bracket 1.

The head 20 may be shaped to receive a tool, for example the head 20 presents a complementary shape with the tool. The tool may be manually operated. For example, during assembly of the lever 2 on the bracket 1 with the assembling element 3, the tool may be received by the head 20 and the rotation of the tool is transmitted to the assembling element 3 so as to rotate the assembling element 3. For example, the tool is received by the recess 22. The tool may be removable to the head 10. Alternatively, the tool may be fixed to the head 10.

The tools may be standard tools, for example standard screwdrivers.

The peripheral part 21 may extend from the side wall 222 radially and/or orthogonally with regards to the assembling element axis Y2.

The peripheral part 21 may present the top surface 211. For example, the top surface 211 faces away from the body 10 and/or the assembling part 30. The top surface 211 may be linked to the side wall 222 and for example may surround the side wall 222.

For example, the top surface 211 of the peripheral part 21 present a circular outer shape and the peripheral lower surface 210 of the peripheral part 21 present a circular outer shape. For example, the top surface 211 and the peripheral lower surface 210 are parallel.

For example, the peripheral lower surface 210 is in contact with the lever 2 when the lever is assembled to the bracket 1, for example with the base portion 200 of the lever 2.

When the lever 2 is assembled to the bracket 1, the lever 2 may not translate away from the bracket 1 because the lever 2 is blocked by the contact of the lever 2 against the peripheral lower surface 210 of the peripheral part 21.

The bottom wall 221 may present at least one bottom opening 220. For example, the bottom wall 221 may present three bottom openings 220.

The skirt part 40 may extend from the head 20, for example from the peripheral lower surface 210 of the peripheral part 21 of the head 20, for example in a direction parallel to the body 10, for example in the direction defined by the axis Y2, for example in the second sense of the axis Y2. For example, when the lever 2 is assembled to the bracket 1, the skirt part 40 extends towards the bracket 1, for example extends around the shaft portion 72 of the bracket 1 and extends inside the base portion 200 of the lever 2. For example, the skirt part 40 is hollow. For example, the skirt part 40 is a single piece.

The skirt part 40 may surround at least a part of the body 10, for example of the assembling element 3, but for example does not surround the assembling part 30. For example, when the lever 2 is assembled to the bracket 1, the skirt part 40 surrounds at least a part of the shaft portion 72 of the bracket 1, for example the skirt part 40 may extend in the same direction as the shaft portion 72 of the bracket 1, the shaft portion 72 and the skirt part 40 extending for example in opposite senses, for example the skirt part 40 may be in contact with the shaft portion 72 of the bracket 1. When the lever 2 is assembled to the bracket 1, the skirt part 40 may be surrounded at least partially by the base portion 200 of the lever 2, for example the skirt part 40 may be in contact with the base portion 200 of the lever 2.

For example, the skirt part 40 comprises a peripheral wall 41. The peripheral wall 41 may present an outer surface 41a and an inner surface 41b. The outer surface 41a may face away from the body 10 of the assembling element 3. The inner surface 41b may face the body 10 of the assembling element 3.

The peripheral wall 41 may be configured such that, when the lever 2 is assembled to the bracket 1, the outer surface 41a of the peripheral wall 41 may face the lever 2 and the inner surface 41b of the skirt part 40 may face the bracket 1, for example the shaft portion 72 of the bracket, for example the outer surface 41a of the skirt part 40 may be in contact with the lever 2 and the inner surface 41b of the skirt part 40 may be in contact with the bracket 1. For example, the outer surface 41a of the skirt part 40 is in contact with the base portion 200 of the lever 2 and the inner surface 41b is in contact with the shaft portion 72 of the bracket 1. The outer surface 41a of the skirt part 40 may allow the rotation of the lever 2 with regards to the bracket 1, when the lever 2 is assembled to the bracket 1, without the need to provide grease between the lever 2 and the skirt part 40. For example, the outer surface 41a, for example the skirt part 40, for example the assembling element 3, is made of a material configured to reduce the coefficient of friction of the outer surface 41a. For example, the outer surface 41a, for example the skirt part 40, for example the assembling element 3, comprises or is made of plastic, for example of polyoxymethylene, so-called POM. For example, the outer surface 41a of the skirt part 40 is treated to reduce its coefficient of friction, for example when the outer surface 41a, for example the skirt part 40, for example the assembling element 3, comprises or is made of a metallic material, for example of metal. The treatment to reduce the coefficient of friction of the outer surface 41a may help the rotation of the lever 2 around the skirt part 40, for example to make the rotation of the lever 2 smoother. The bracket 1 and/or the lever 2, or levers 2 as described hereinafter, can comprise plastic and/or glass fibers, for example be made of plastic and glass fibers. The reduction of friction from the outer surface 41a thus helps limiting the wear of the bracket and/or of the lever(s), in particular when they are in such materials which tend to cause frictions.

For example, when the lever 2 is assembled to the bracket 1, the outer surface 41a of the skirt part 40 may be in contact with an inner surface 200b of the base portion 200 of the lever 2. For example, when the lever 2 is assembled to the bracket 1 and that the lever 2 rotates with regards to the bracket 1, the inner surface 200b of the base portion 200 may be in contact with the outer surface 41a of the skirt part 40 while moving with regards to the outer surface 41a of the skirt part 40.

The inner surface 200b of the base portion 200 is for example treated to reduce its coefficient of friction. The treatment to reduce the coefficient of friction of the inner surface 200b may help the rotation of the lever 2 around the skirt part 40, for example to make the rotation of the lever 2 smoother, for example reducing the friction generated between the lever 2 and the skirt part 40 for example without needing to add grease or only a reduced amount of grease between the lever 2 and the skirt part 40.

For example, the skirt part 40 presents a tubular shape. For example, the base portion 200 presents a tubular shape.

With reference to FIGS. 9a to 11b, the bracket 1 of the door handle 90 of a vehicle is described.

The bracket 1 may be configured to be assembled the at least one lever 2 by means of the assembling element 3. The bracket 1 may present at least one opening, for example the opening 70, configured such that, when the bracket 1 is assembled to the lever 2, the body 10 of the assembling element 3 is inserted through the opening 70 of the bracket 1.

For example, as illustrated in FIGS. 9a and 9b, the bracket 1 presents two openings 70, for example the bracket 1 is configured to be assembled to two such levers 2 by means of two such assembling elements 3, for example each lever of the two levers 2 is assembled in one opening of the two openings 70 with one such assembling element 3 of the two assembling elements 3.

The bracket may comprise a main wall 75. The main wall 75 may present the first side 1a and the second side 1b. The opening 70 may go through the main wall 75.

The bracket 1 may comprise, for example for one or more or each opening of the opening(s) 70, the shaft portion 72, for example extending for example in the direction of the axis of rotation Y1. The shaft portion 72 may be hollow, for example so as to extend around the body 10 and/or the head 20 of the assembling element 3, when the lever 2 is assembled to the bracket 1.

The shaft portion 72 may extend at least partially from the main wall 75, for example from the first side 1a of the bracket 1. For example, the shaft portion 72 includes a shaft wall 721 extending from the main wall 75, for example from the first side 1a of the bracket 1.

The shaft portion 72 may include a first protruding section, for example corresponding to a section delimited by the shaft wall 721. The shaft portion 72 may include a second inner portion, extending within the main wall 75. The first protruding section and the second inner section may be defined along the first axis Y1.

The shaft portion 72 may present an outer surface 72a and an inner surface 72b. When the bracket 1 is assembled to the lever 2, the outer surface 72a of the shaft portion 72 may face away from the body 10 of the assembling element 3 and the inner surface 72b of the shaft portion 72 may face the body 10 of the assembling element 3. The outer surface 72a is for example an outer surface of the shaft wall 721.

The shaft portion 72 of the bracket 1 is for example configured to support the assembling element 3, for example the skirt part 40 of the assembling element 3.

The bracket 1 may comprise at least two stops, for example a plurality of stops, including for example the two stops 50, the stops of the plurality of stops corresponding for example to one or the other of the two stops 50 described hereabove that are configured to sandwich at least one protrusion 31 of the assembling element 3. For example, as illustrated in FIG. 10, the plurality of stops of the bracket 1 comprises pairs of stops 50, such as the above-described two stops 50, for example six stops 50 organized in three pairs of stops. The at least the two stops 50 may be located on the second side 1b of the bracket 1, for example around the opening 70 of the bracket 1, for example in contact with the opening 70. Each stop of the at least the two stops 50 may form a protrusion of the main wall 75 of the bracket 1.

The at least two stops 50 may comprise the first stop 51 and the second stop 52. The first stop 51 may comprise the ramp 60. The first stop 51 may comprise a side wall 512. The side wall 512 of the first stop 51 may extend from the main wall 75, for example from the second side 1b of the bracket 1, from example in the direction of the axis of rotation Y1. The side wall 512 of the first stop 51 may link the main wall 75 and the ramp 60 of the second stop 52. The ramp 60 may be curved and/or inclined, for example rounded curved and /or inclined. The side wall 512 of the first stop 51 may comprise the first stop face 510.

The second stop 52 may comprise an upper wall 521 and a side wall 522. The side wall 522 of the second stop 52 may extend from the main wall 75, for example from the second side 1b of the bracket 1, from example in the direction of the axis of rotation Y1. The side wall 522 of the second stop 52 may link the main wall 75 and the upper wall 521 of the second stop 52. The upper wall 521 of the second stop 52 may be parallel to the main wall 75. The side wall 522 of the second stop 52 may comprise the second stop face 520.

For example, when the at least one protrusion 31 is sandwiched between the two stops 50, the at least one protrusion 31 may be blocked by the contact of the first stop surface 31a of the at least one protrusion 31 against the side wall 512 of the first stop 51, for example by the first stop face 510, and by the contact of the second stop surface 31b of the at least one protrusion 31 against the side wall 522 of the second stop 52, for example by the second stop face 520. When the at least one protrusion 31 is sandwiched between the two stops 50, the at least one protrusion 31 may be blocked by the contact of the second face 330 of the at least one protrusion 31 against the side wall 522 of the second stop 52, for example against the second stop face 520. When the at least one protrusion 31 is sandwiched between the two stops 50, the at least one protrusion 31 may be blocked by the contact of the first face 320 of the at least one protrusion 31 against the side wall 512 of the first stop 51, for example against the first stop face 510.

The first stop 51 and the second stop 52 are spaced apart so as to form a space 53, for example the space 53 is formed by the side wall 512 of the first stop 51, the side wall 522 of the second stop 52 and the main wall 75. For example, when the at least one protrusion 31 is sandwiched between the two stops 50, the at least one protrusion 31 is located in the space 53.

The side wall 522 of second stop 52 may extend further from the main wall 75 than the side wall 512 of the first stop 51. It may allow, when the at least one protrusion 31 is sandwiched between the two stops 50, the at least one protrusion 31 to be blocked by the contact of the flat surface 331 of the at least one protrusion 31 against the side wall 512 of the first stop 51.

The bracket 1, for example the shaft portion 72, for example each shaft portion 72, may comprise at least one slide 71, for example one or several slide(s) 71. The slide(s) may be extending within the opening 70. The at least one slide 71 is for example located on the inner surface 72b of the shaft portion 72, for example extending inwards of the shaft portion 72, and for example extending from the first side 1a in a direction parallel to the axis of rotation Y1.

The at least one slide 71 may be configured to guide the assembling part 30 through the bracket 1, for example the protrusion 31 or one of the protrusions 31, for example during the insertion of the assembling element 3 through the shaft portion 72. For example, for each of the protrusions 31 of the assembling element 3, the bracket 1, for example the shaft portion 72, comprises one such corresponding slide 71 configured to guide the or one of the protrusion(s) 31 of the assembling element 3, for example during the insertion of the assembling element 3 through the shaft portion 72. For example, the bracket 1, for example the shaft portion 72, comprises three such slides 71, corresponding to the three protrusions 31 of the assembling element 3, configured to guide the three protrusions 31 of the assembling element 3 during insertion of the assembling element 3 through the shaft portion 72.

The slide 71, for example each slide 71, may include a pair of slide walls 73. The slide walls 73 may be extending from the inner surface 72b, for example from the shaft wall 721, for example to a tip, for example a rounded tip. The two corresponding walls 73 may be parallel. The slides 73 may also be extending from the main wall 75, for example the shaft 73 extending higher from the main wall than the slide walls 73. Slide walls 73 may be connected to another of the slide walls 73 from a different pair by a connecting portion 751, the connecting portion being for example part of the main wall 75 and for example extending in the continuity of the neighbouring zone of the main wall 75.

The slide 71, for example each slide 71, may include a recess 722. The recess may extend within the shaft wall 721 and/or within the bracket main wall 75. The corresponding pair of slide walls 73 may extend on both sides of the recess 722.

As illustrated in FIG. 11a, the opening 70 may present a star shape. For example, the opening 70 presents a central, for example round, opening 70a from which at least one arm opening 70b extends, for example extends radially with regards to the axis of rotation Y1, for example so as to define a corresponding slide 71. For example, the opening 70 presents three arm openings 70b extending from the central opening 70a, corresponding to the three slides 71.

The central opening 70a may be configured to allow the body 10 of the assembling element 3 to be inserted through the bracket 1, for example through the main wall 75. For example, the at least one arm opening 70b is configured to allow the at least one protrusion 31 of the assembling element 3 to be inserted through the bracket 1, for example through the main wall 75.

For example, as illustrated in FIGS. 11a and 11b, the shaft portion 72 may present three such slides 71, each delimited by two such slide walls 73.

For example, in the assembly 100 for a door handle, the assembling element 3 and the bracket 1 may be configured such that, the assembling part 30 and the head 20 limit translation in any direction of the assembling element 3, and for example of the lever 2, with respect to the bracket 1.

For example, in the assembly 100, the lever can only rotate around the axis of rotation Y1 and cannot translate in any direction with regards to the bracket 1.

For example, in the assembly 100 for a door handle, the assembling element 3 and the bracket 1 may be configured such that, the assembling part 30 limits rotation of the assembling element 3 with respect to the bracket 1.

For example, in the assembly 100 for a door handle, the assembling element 3 and the lever 2 may be configured such that, the assembling element 3 allows and guides the rotation of the lever 2 with respect to the bracket 1, for example with respect to the assembling element 3, for example around the axis of rotation Y1.

For example, in the assembly 100 for a door handle, the assembling element 3 is supported on the bracket 1, for example on the shaft portion 72 of the bracket 1. For example, the contact between the shaft portion 72 of the bracket 1 and the skirt part 40 of the assembling element 3 allows the assembling element 3 to be supported by the bracket 1.

For example, in the assembly 100 for a door handle, the lever 2 is mounted so as to surround the skirt part 40 of the assembling element 3. For example, the lever 2 is supported on the bracket 1, for example on the shaft portion 72 of the bracket 1.

For example, in the assembly 100 for a door handle, the head 20 of the assembling is partially inserted though the shaft portion 72, particularly the bottom wall 221 and the side wall 222 of the head 20 are partially inserted though the shaft portion 72.

For example, in the assembly 100 for a door handle, the body 10 of the assembling element 3 passes though the opening of protrudes of the second side 1b of the bracket 1.

For example, in the assembly 100 for a door handle, the at least one protrusion 31 of the assembling part 30 is sandwiched between the two stops 50 of the bracket 1.

The assembling element 3 and the lever 1 may be configured such that, when the lever 2 is assembled to the bracket 1, the skirt part 40 and the lever 2 are configured in such a way that the lever 2 may rotate with regards to the assembling element smoothly, and/or without reducing the friction generated between the lever 2 and the skirt part 40, and/or without the need to add grease between the lever 2 and the skirt part 40, or only a reduced amount of grease between the lever 2 and the skirt part 40, for example the skirt part 40 and the lever 2 are configured in such a way that the surfaces of the skirt part 40 and of the lever 2 that are in contact present a reduced coefficient of friction, for example a low coefficient of friction.

A door handle of a vehicle is described. The door handle 90 may comprise the assembly 100 for a door handle, for example wherein the lever 2 is assembled to the bracket 1 by means of the assembling element 3.

A vehicle door is described. The vehicle door may comprise the door handle 90. The vehicle door may comprise a vehicle door panel. The handle 90 may be mounted to another part of the vehicle door, for example to the vehicle door panel. The vehicle door is for example a front, lateral or rear door.

A vehicle is described. The vehicle may comprise one or more such vehicle door(s).

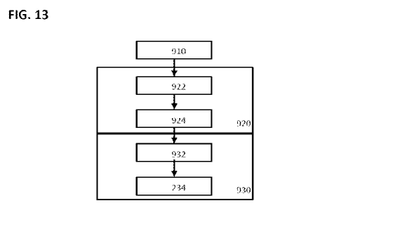

With reference to FIG. 13, a method of assembly of the lever 2 to the bracket 1 of the door handle 90 may be implemented. The method of assembly may comprise one or more of the following steps.

The method of assembly of the lever 2 to the bracket 1 of the door handle 90 may comprise a first step 910 wherein the lever 2 is positioned on the bracket 1. During the first step 910, the lever 2 may be positioned on the first side 1a of the bracket 1, for example so as to surround the shaft portion 72 of the bracket 1, for example so that the base portion 200 surrounds the shaft portion 72.

The lever 2 may be positioned on the bracket 1 thanks to a tool and/or manually, for example by an operator.

At the end of the first step 910, the lever 2 may surround the shaft portion 72 and may be able to rotate and translate with regards to the bracket 1, for example in all of the directions.

The method of assembly may comprise a second step 920, for example following the first step 910 wherein the assembling element 3 is inserted at least partially though the bracket 1. The method, for example the moving of the assembling element, may be implemented thanks to a tool and/or manually, for example by an operator.

The method of assembly may comprise a first sub-step 922 of the second step 920 wherein the assembling part 30 is inserted through the shaft portion 72 of the bracket 1. During the first sub-step 922 of the second step 920, the at least one protrusion 31 may be guided by a least one slide 71, for example one or more slide(s) 71 as described hereabove, until the at least one protrusion 31 reaches the second side 1a of the bracket 1a.

The method of assembly may comprise a second sub-step 924 of the second step 920, for example following the first sub-step 922 of the second step 920, wherein the assembling part 30 passes through the opening 70, for example from the first side 1a of the bracket 1, and reaches for example the second side 1b. For example, during the second sub-step 924 of the second step 920, the assembling part 30 passes though the opening 70 of the bracket 1 so that the assembling part 30 protrudes from the second side 1b of the bracket 1.

For example, the first step 910, the head 20 moves closer to the lever 2 until the head 20 comes into contact with the lever 2, for example with the base portion 200 of the lever 2.

For example, during the first step 910, the skirt part 40 moves closer to the bracket 1 until the skirt part 40 is inserted at least partially between the bracket 1 and the lever 2 in a direction orthogonal to the axis of rotation Y1, for example between the base portion 200 of the lever 2 and the shaft portion 72 of the bracket 1.

For example, the first step 910, the assembling element 3 may be only pushed toward the bracket 1 to be inserted though the bracket 1, for example from the first side 1a of the bracket 1.

At the end of the second step 920, the assembling part 30 may be fully past the second side 1b of the bracket 1, for example the at least one protrusion 31 may be fully past the second side 1b of the bracket 1; for example lying on the second side 1b of the bracket 1. At the end of the second step 920, the head 20 may be in contact with the lever 2, for example the peripheral lower surface 210 may be in contact with the lever 2, for example with the base portion 200 of the lever. At the end the second step 920, the body 10 may be located at least partially through the bracket 1. At the end of the second step 920, the skirt part 40 may be located at least partially between the bracket 1 and the lever 2 in a direction orthogonal to the axis of rotation Y1, for example between the base portion 200 of the lever 2 and the shaft portion 72 of the bracket 1, allowing the lever 2 to rotate with respect to the skirt part 40 around the axis of rotation Y1.

It may be not necessary to add grease to the lever 2, or to the bracket 1, or to the assembling element 3 to ensure rotation of the lever 2 with regards to the bracket.

The method of assembly of the lever 2 to the bracket 1 of the door handle 90 may comprise a third step 930, for example following the second step 920, wherein the assembling element 3 is rotated, for example while being located though the bracket 1. During the third step 930, the assembling may be rotated around the axis of rotation Y1, and for example around the assembling element axis Y2. The assembling element 3 may be rotated thanks to a tool and/or manually, for example by the operator.

The method of assembly may comprise a first sub-step 932 of the third step 930, wherein the assembling element 3 may be rotated in such a way that the at least one protrusion 31 slides on the ramp 60, for example until the at least one protrusion 31 reaches an upper end of the ramp 60, and goes beyond the upper end, such that the at least one protrusion 31 is no longer maintained by the ramp, in particular is no longer in contact with the ramp 60. During the first sub-step 932 of the third step 930, the at least protrusion 31 may be deformed, for example bent, from an initial shape into a strained shape.

The method of assembly may comprise a second sub-step 934 of the third step 930, for example following the first sub-step 932 of the third step 930, wherein the at least protrusion 31 moves back, for example in translation, for example following the first sense of the axis Y1, until being blocked by the second side 1b and/or being trapped, for example sandwiched, between the two stops 50 of the bracket 1. During the second sub-step 934 of the third step 930, the at least protrusion 31 may return, for example from the strained shape to the initial shape.

At the end of the third step 930, for example at the end of the second sub-step 934 of the third step 930, the at least one protrusion 31 is sandwiched between the two stops 50, for example located in the space 53.

At the end of the third step 930, for example at the end of the second sub-step 934 of the third step 930, the lever 2 is assembled to the bracket 1, for example the lever 2 is maintained between the head 20 of the assembling element 3 and the bracket 1.

Thanks to this method of assembly of the lever 2 to the bracket 1 of the door handle 90, it may be possible to assemble the lever 2 to the bracket 1 using a unique fastener, for example the assembling element 3. This may reduce the number of assembly steps.

Thanks to this method of assembly of the lever 2 to the bracket 1 of the door handle 90, it may be not needed to pivot the lever 2 to assemble the lever 2 to the bracket 1 but only to rotate the assembling element 3, thus there may be no significant structural constraint on the bracket 1 to avoid collision between the lever 2 and the bracket 1 during pivoting of the lever 2. It may allow a simple assembly in a limited space.

Thanks to this method of assembly of the lever 2 to the bracket 1 of the door handle 90, the assembling of the lever 2 on the bracket 1 may be realized by having access to only one side of the bracket 1, for example the first side 1a of the bracket 1. This may avoid the need for access to both sides of the bracket 1 during the assembly of the lever 2 to the bracket 1. For example, this makes assembly easier and saves time.

Thanks to this method of assembly of the lever 2 to the bracket 1 of the door handle 90, it may be not needed to add grease between the bracket 1 and the lever 2, this may eliminate an assembly step and reduces the cost of assembly.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An assembling element configured to assemble a lever to a bracket of a door handle of a vehicle in such a way that the lever can rotate with respect to the bracket around an axis of rotation,
the assembling element comprising a head and a skirt part wherein the head is located at a first end of the assembling element, and
the assembling element being configured such that, when the lever is assembled to the bracket, the skirt part is located at least partially between the bracket and the lever in a direction orthogonal to the axis of rotation, allowing the lever to rotate with respect to the skirt part around the axis of rotation.

2. The assembling element according to claim 1, wherein the assembling element comprises a body, wherein the skirt part extends from the head, the skirt part surrounding at least a part of the body, the body being connected to the head and the body being configured to be inserted through the bracket.

3. The assembling element according to claim 1, wherein the skirt part comprises a peripheral wall, the peripheral wall presenting an outer surface and an inner surface, the peripheral wall being configured such that, when the lever is assembled to the bracket, the outer surface of the skirt part is in contact with the lever and the inner surface is in contact with the bracket.

4. The assembling element according to claim 3, wherein the outer surface of the skirt part is treated to reduce a coefficient of friction of the skirt part.

5. The assembling element according to claim 2, wherein the assembling element comprises an assembling part, wherein the assembling part is located at a second end of the assembling element opposite to the first end, the body connecting the head and the assembling part, the assembling part having a shape configured to maintain the lever between the bracket and the head in the direction of the axis of rotation when the lever is assembled to the bracket.

6. The assembling element according to claim 5, wherein the assembling part is configured to be inserted though the bracket from a first side of the bracket such that, when the lever is assembled to the bracket, the lever is located on the first side of the bracket.

7. The assembling element according to claim 5, wherein the assembling part comprises at least one protrusion configured to be trapped between two stops of the bracket when the lever is assembled to the bracket, so as to limit the rotation of the assembling element with respect to the bracket.

8. The assembling element according to claim 2, wherein the assembling element is configured to be rotated with respect to the bracket around the axis of rotation, to assemble the lever to the bracket, once the body is inserted through the bracket.

9. The assembling element according to claim 7, wherein the at least one protrusion presents a rounded curved and/or inclined surface configured such that, upon rotation of the assembling element with respect to the bracket around the axis of rotation, the rounded curved and/or inclined surface slides on a ramp of the bracket.

10. The assembling element according to claim 9, wherein the head comprises a peripheral part configured such that, when the lever is assembled to the bracket, the lever is located at least partially between the peripheral part and the bracket in the direction to the axis of rotation.

11. The assembling element according to claim 10, wherein the head presents a recess delimited by a bottom wall and a side wall of the head, the recess extending from the bottom wall, away from the body and/or the assembling part, the recess opening out through a top surface of the head, the top surface facing away from the body and/or the assembling part.

12. A bracket of a door handle of a vehicle, the bracket being configured to be assembled to at least one lever by means of an assembling element according to claim 2, the bracket presenting an opening configured such that, when the bracket is assembled to the lever, the body of the assembling element is inserted through the opening.

13. An assembly for a door handle comprising at least one lever and a bracket configured to be assembled to the at least one lever by means of at least one assembling element according to claim 1.

14. The assembly according to claim 13, wherein the assembling element and the bracket are configured such that, when the lever is assembled to the bracket, the skirt part and the lever are configured in such a way that the lever may rotate with regards to the assembling element without a need to provide grease between the lever and the skirt part.

15. A door handle of a vehicle comprising the assembly of claim 14, wherein the lever is assembled to the bracket by means of the assembling element.
